(19) United States
(12) Patent Application Publication
(10) Pub. No.: US 2011/0229611 A1
(43) Pub. Date: Sep. 22, 2011

(54) SYSTEM AND METHOD FOR FOOD PRODUCT ASSEMBLY

(75) Inventors: Debra A. Sommerio, Hanover Park, IL (US); David S. Oufnac, Chicago, IL (US); Timothy A. Stubbs, Glenview, IL (US); Kent M. Bearson, Naperville, IL (US)

(73) Assignee: Sara Lee Corporation

(21) Appl. No.: 13/048,744

(22) Filed: Mar. 15, 2011

Related U.S. Application Data
(60) Provisional application No. 61/314,499, filed on Mar. 16, 2010.
(60) Provisional application No. 61/392,166, filed on Oct. 12, 2010.

(51) Int. Cl. B65B 25/06; A23J 1/02; A23P 1/00

(52) U.S. Cl. 426/129; 426/412; 426/656; 426/383

(57) ABSTRACT

A method of making a food product includes forming a first food component; providing a filling to the first food component; forming a second food component and providing the second food component on the first food component and the filling wherein the first food component is in contact with the second food component at least about their respective peripheries; sealing the first and second food components and the filling within a packaging and applying a vacuum to the packaging; cooking the first and second food components and the filling within the packaging to bond the first and second food components together.

### CROSS-REFERENCE TO RELATED PATENT APPLICATIONS

This application claims the benefit of priority of U.S. Provisional Application No. 61/314,499, filed Mar. 16, 2010. This application also claims the benefit of priority of U.S. Provisional Application No. 61/392,166, filed Oct. 12, 2010. Both of these applications are incorporated by reference herein.

### BACKGROUND

The present disclosure relates generally to the field of food product assembly. More specifically, the disclosure relates to the assembly of food products including multiple component types.

Conventional stuffed food products (e.g., any food product including an outer portion and an inner filling) are generally formed in one of a few ways. For example, stuffed products may be generated by an automated extrusion process. While this process is relatively inexpensive, it uses uncooked emulsified meats it may be difficult to present the food product as a single homogeneous or seamless food item. Alternatively, the stuffed products may be formed by a manual process using whole muscles. However, the manual process takes considerable time and is much more expensive. It would be desirable if an automated process could produce a food product that was seamless.

### SUMMARY

One embodiment relates to a method of making a food product, the method comprising forming a first food component; providing a filling to the first food component; forming a second food component and providing the second food component on the first food component and the filling wherein the first food component is in contact with the second food component at least about their respective peripheries; sealing the first and second food components and the filling within a packaging and applying a vacuum to the packaging; cooking the first and second food components and the filling within the packaging to bond the first and second food components together.

Another embodiment relates to a method of making a food product, the method comprising forming a first food component; positioning a filling on top of the first food component; forming a second food component; positioning the second food component on the first food component and the filling to enclose the filling between the first and second food components; sealing the first and second food components and the filling within a packaging and applying a vacuum to the packaging; at least partially cooking at least one of the first and second food components.

Another embodiment relates to a method of making a food product, the method comprising extracting meat proteins from meat; forming a first meat-based food component; positioning a filling on the first meat-based food component; forming a second meat-based food component ; positioning the second meat-based food component on the first meat-based food component; sealing the first and second meat-based food components and the filling within a packaging and applying a vacuum to the packaging; wherein extracted meat proteins in the first and second meat-based food components provides a sealable area between the first and second meat-based food components, the sealable area configured to provide a bond between the first and second meat-based food components when the first and second meat-based food components are cooked.

Another embodiment relates to a packaged food product comprising a first meat-based food component; a second meat-based food component; a first filling located between the first meat-based food component and the second food meat-based component; sealed vacuum packaging containing the first meat-based food component, the filling, and the second meat-based food component; wherein at least an outer periphery of the first meat-based food component is bonded to an outer periphery of the second meat-based food component by heat applied to the sealed vacuum packaging.

### BRIEF DESCRIPTION OF THE DRAWINGS

FIG. 1 is a schematic view illustrating various food components of a food product according to an alternative embodiment.

FIG. 2 is a schematic view illustrating an assembled food product including the food components of FIG. 1 according to an exemplary embodiment.

FIG. 3 is a schematic view illustrating the assembled food product of FIG. 2 in a vacuum packaging according to an exemplary embodiment.

FIG. 4 is a block diagram illustrating a method of making a food product according to an exemplary embodiment.

FIG. 5 is a schematic representation of various steps included in making a food product according to an exemplary embodiment.

FIG. 6 is a schematic view illustrating a portion of a system for making a food product according to another exemplary embodiment.

FIG. 7 is a schematic view illustrating a portion of a system for making a food product according to an exemplary embodiment.

FIG. 8 is an overhead schematic view of a food product assembly system according to an exemplary embodiment.

FIG. 9 is a schematic view of steps in the assembly of a food product using the system of FIG. 8 according to an exemplary embodiment.

FIG. 10 is a perspective view of a mold for forming a food product according to an exemplary embodiment.

FIG. 11 is a perspective view of the mold of FIG. 10 including food components according to an exemplary embodiment.

FIG. 12 is a cross section of the mold of FIG. 10 illustrating the food components being compressed according to an exemplary embodiment.

FIG. 13 is a perspective view of the bottom mold of FIG. 10 including a compressed food component according to an exemplary embodiment.

FIG. 14 is a perspective view of multiple compressed food components and a filling according to an exemplary embodiment.

FIG. 15 is a schematic view illustrating the operation of a retracting belt system in the system of FIG. 8 according to an exemplary embodiment.

FIG. 16 is an overhead schematic view of a food product assembly system according to another exemplary embodiment.

### DETAILED DESCRIPTION OF EXEMPLARY EMBODIMENTS

Various embodiments disclosed herein relate to food products, and systems and methods for making food products (e.g., stuffed food products, etc.). According to an exemplary embodiment, a stuffed food product includes an outer layer or portion and an inner layer or portion. The outer portion may be a protein-based or other component (e.g., meat, bread, dough, grain products, dairy products, combinations thereof, etc.). The inner layer may be a stuffing or filling comprising a vegetable, fruit, dairy, another meat, grain-based products, rice, sauce, seasoning, cheese-product, etc., or combinations thereof. As discussed in greater detail below, in one embodiment, a method of making the food product includes forming first and second food components, providing a filling component between the first and second food components, sealing the first and second food components and the filling component within a packaging and applying a vacuum to the packaging, and cooking the first and second food components and the filling within the packaging to bond the first and second food components together.

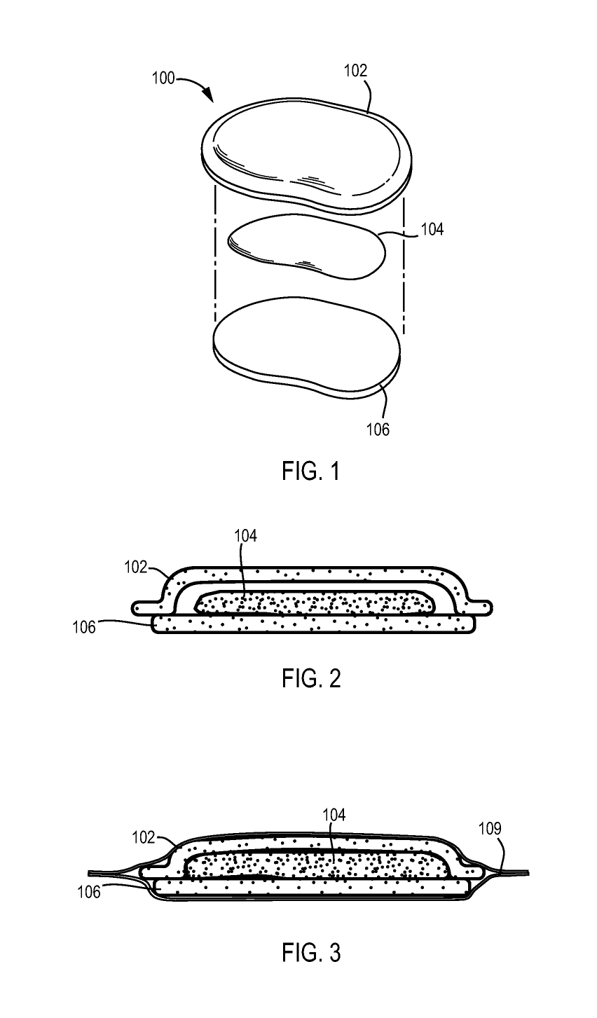

Referring now to FIGS. 1-3, according to some embodiments, a stuffed protein food product 100 includes a top or first food component 102, a second or bottom food component 106, and a filling 104. In some embodiments, the top and/or bottom components 102, 106 are meat and/or protein-based food components. However, as discussed above and according to various other embodiments, one or more of the top component, bottom component, or filling may be a non-meat or non-protein based component, such as cheese, dough, or bread-based component. For example, some food products may include a meat-based bottom component, a filling component, and a cheese-based top component. The types of components used in making the food products disclosed herein may vary according to various alternative embodiments.

In some embodiments top and bottom components 102, 106 may be substantially mirror images of each other (see, e.g., FIG. 14). For example, top and bottom components 102, 106 may have the same general shape (e.g., pork chop, etc.) and have generally same sized recesses (e.g., to accept a filling). According to other embodiments, for example, as shown in FIG. 1, the top and bottom components 102, 106 may be different-sized and have different-sized and/or shaped recesses (or one or both of the top or bottom components may be provided without a recess entirely). Any suitable size/shape of top and bottom components 102, 106 may be utilized that provides for proper containment of filling 104 and proper contact (e.g., binding, sealing, “gluing,” bonding, etc.) between top and bottom components 102, 106.

As indicated above, top and bottom components 102, 106 may be mirror images of one another such that the outside portions or edges of the top and bottom components contact each other and may be sealed around the filling component (e.g., via a heating / cooking process). Alternatively, as shown in FIGS. 1 and 2, the bottom component may or may not include a recess to receive the filling component, and the top component may be larger than the bottom component such that the top component “drapes” over the stuffing, and possibly also the bottom component, and at the same time contacts the bottom component in a sealable/bindable manner (e.g., about an outer or peripheral portion of the bottom component). In yet further embodiments, rather than the top component being larger than the bottom component, the top component may instead be smaller than the bottom component (e.g., in the case of utilizing a molded film, etc.).

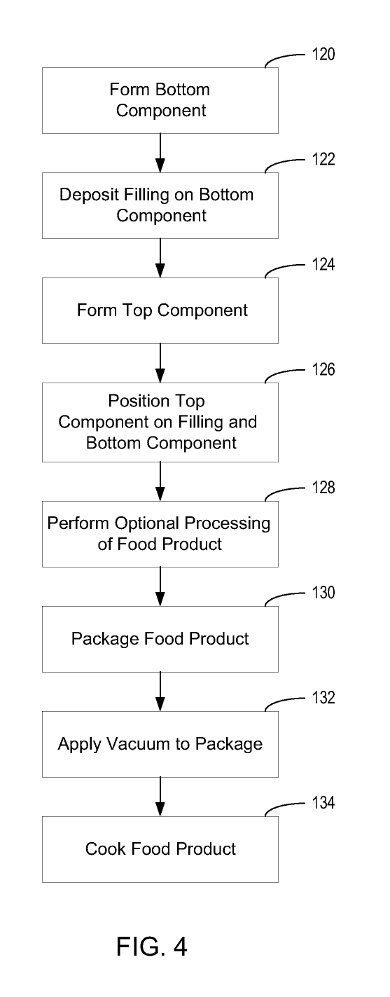

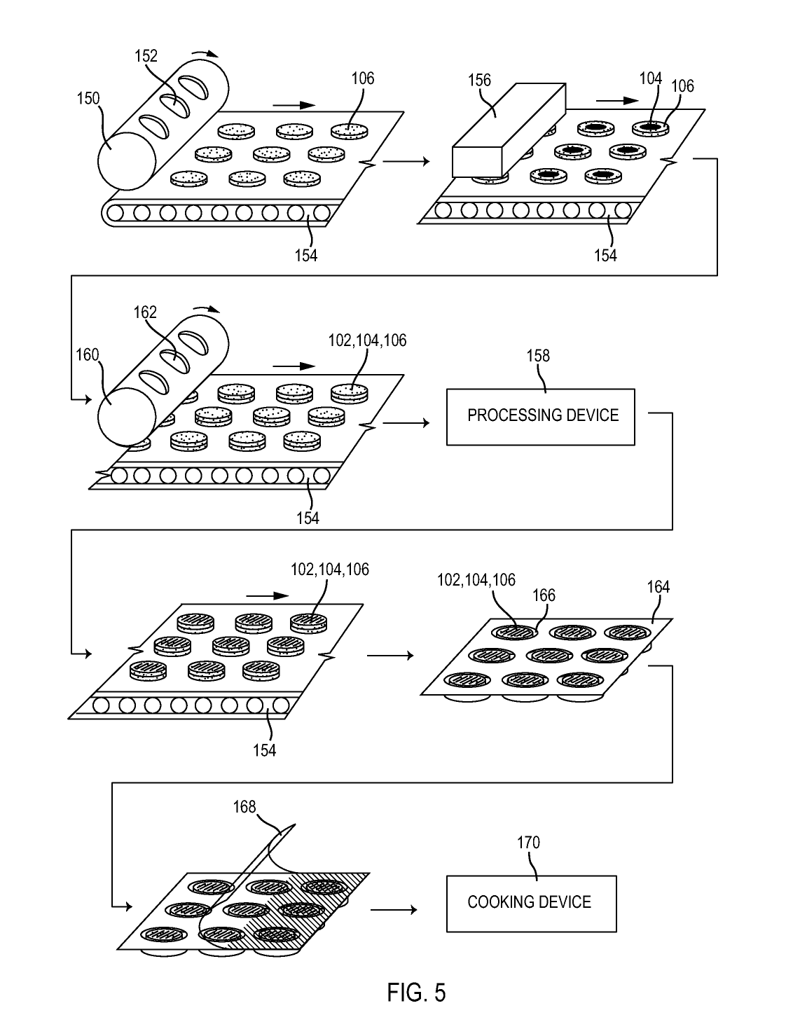

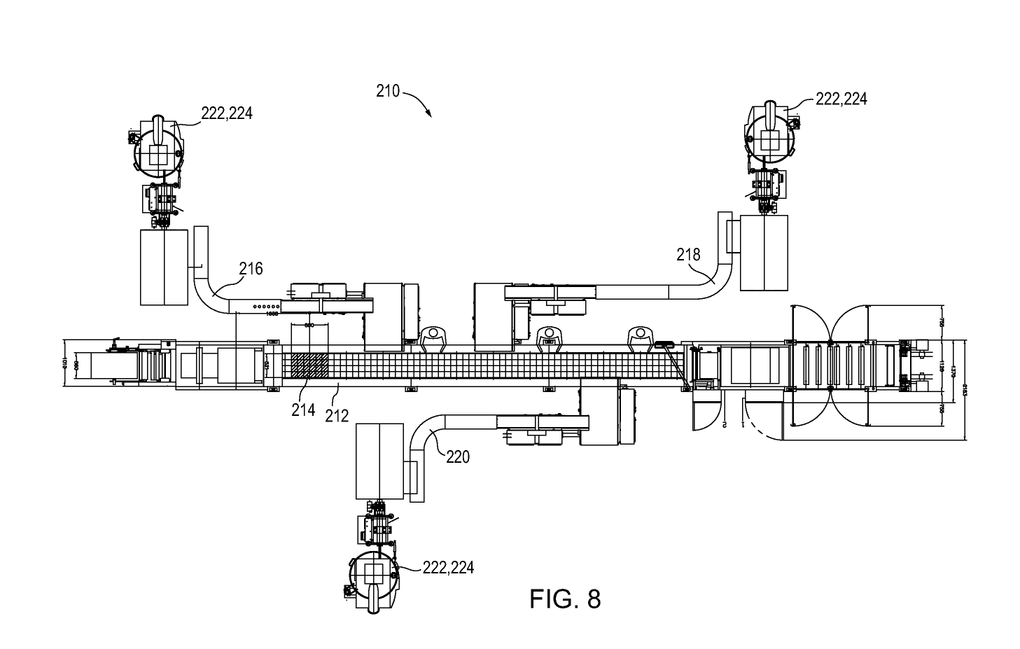

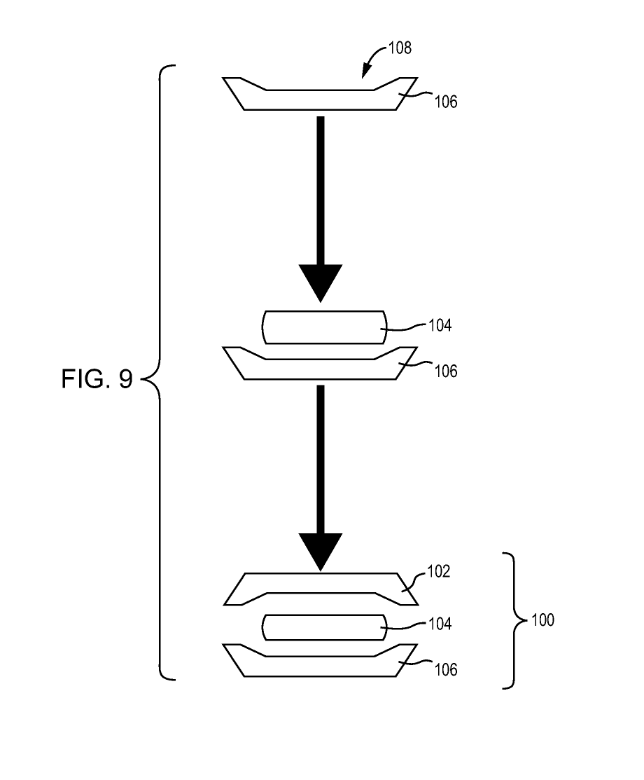

During formation and packaging of food product 100, the food product 100 may be placed (e.g., using any methods described herein or other suitable methods) into a formed pocket or receptacle (see, e.g., FIG. 9) one component at a time (e.g., as discussed with reference to FIGS. 8 and 9), or alternatively, the food product components may be pre-assembled and then placed in the assembled state into a formed pocket or receptacle (see, e.g., FIGS. 4-5). A top layer of film may then be sealed over the receptacle to form a packaging (see packaging 109 in FIG. 3) to seal the food product. In other embodiments, a bag or other packaging may be used to package the food product.

According to some embodiments, in order to provide a proper integration (e.g., joining, sealing, etc.) between components (e.g., between a top meat-based component and a bottom meat-based component), meat-based components may be bonded to each other. To accomplish bonding of the components, meat proteins are extracted from the meat-based components through mixing, massaging (e.g., using salt, phosphate, water, and/or other non-meat ingredients), and the like, until the meat-based components become pliable and tacky (e.g., such that the meat components have a “tacky” or “sticky” feel or texture). In some embodiments, meat proteins may be extracted from ground product (e.g., ground meat, etc.). After the meat-based components are pliable and tacky, the components may be brought into contact with each other such that the top and bottom components coagulate together and the meat proteins denaturate as a result of heating / cooking or other processes. According to an exemplary embodiment, meat proteins are extracted from meat prior to the top and bottom food components being formed, although extraction of proteins may occur at other steps during the production of the food components and final food product. Extracting meat proteins from meat may facilitate formation of the individual top and bottom components and later bonding of the top and bottom components together. In one embodiment, the top and bottom components are sized relative to the filling such that the top and bottom components are able to contact each other around a portion or the entire perimeter of the food product to create a proper bond between the components. In further embodiments, a separate binder material may be utilized to promote binding of the components.

According to one embodiment, as shown in FIG. 3, the packaging 109 may be vacuum packaged / vacuum sealed about food product 100 prior to cooking food product 100. Alternatively, food product 100 may be cooked or partially cooked (e.g., in a bag or similar item) or undergo other processing (e.g., grill-marking, char-marking, flame-grilling, belt-grilling, seasoning, etc.) prior to vacuum packaging / sealing. In some embodiments, the film / bag used to package the food product may further have shrink characteristics such that the film and/or bag may be shrinkable about the food product (e.g., upon exposure to heat, etc.). After sealing/vacuuming and/or heat-shrinking the package 109 about the food product 100 , the food product 100 may be cooked. The vacuum sealing, heat shrinking, and/or pressing are intended to further bond the top and bottom components 102, 106 together. It should be noted that cooking the food component 100 in a vacuum sealed packaging 109 may promote sealing or bonding of the top and bottom food components 102, 106 (e.g., by “pressing” the top and bottom components together as a result of application of the vacuum and/or through the use of a shrinkable packaging material) and provide a natural appearance to the food product 100 (e.g., such that a chicken-based food product made according to the embodiments disclosed herein may closely resemble, for example, a cooked natural chicken breast or other “natural” food item).

Referring now to FIGS. 4-5, an exemplary process for making a food product is shown according to an exemplary embodiment. First, a bottom component is formed (step 120). In one embodiment, a bottom component such as bottom component 106 may be formed via a rotary forming process (see FIG. 5) such that food material (e.g., meat portions, etc.) is pumped into a recess 152 in a rotary former 150 and the rotary former deposits (e.g., ejects, releases, etc.) a formed component such as bottom component 106 onto a conveyor 154 or other surface or device. A filling such as filling 104 may then be deposited onto bottom component 106 (step 122). Any suitable depositor 156 may be used to deposit filling 104 onto bottom component 106. Top component 102 is then formed (step 124) and positioned on top of bottom component 106 and filling 104 (step 126) to enclose filling 104 within the top and bottom food components. According to various embodiments, one or both of the top and bottom components may be flat, or alternatively, may include a recess to accommodate all or a portion of the filling. Top component 102 may be formed using the same method as bottom component 106, or alternatively may be formed using any other suitable method.

In some embodiments, the top/bottom components and filling then may optionally be processed prior to packaging (step 128) (e.g. using a processing device 158 shown in FIG. 5). For example, a cooking and/or surface treatment (e.g., partially cooking/par-cooking, char-marking, flame-grilling, grill-marking, seasoning, a combination thereof, etc.) may be applied to or performed on one or more of the food components. In some embodiments, the optional processing may occur to an outer side of one or both of the top and bottom food components prior to the top/bottom food components and filling being assembled (e.g., such that only the outer surface of the food component receives the cooking, surface treatment, etc.). The food components and filling are then packaged (step 130). In one embodiment (see FIG. 5), the food components and filling are placed into receptacles 166 in a formed first film 164 (e.g., a polymer tray, etc.) and a second film 168 is sealed to first film 164 to seal the various components within recesses 166, as shown in FIG. 5. Alternatively, bag-like packaging or other packages may be utilized. A vacuum may then be applied to the packaging to remove excess air from the packaging end to compress the food components and filling (e.g., to ensure a good bond between the first and second food components around the filling) (step 132). In some embodiments, a vacuum may be applied to the packaging as the packaging is being sealed. The packaging/food components/filling may then be cooked (step 134) to bond the top and bottom food components together. Any suitable cooking device 170 and/or method may be used, including steaming, boiling, a dry oven, combinations thereof, etc. Alternatively, the various components may be partially-cooked, or left un-cooked (e.g., for later cooking by the consumer). It should be noted that the various steps illustrated in FIG. 5 may be performed utilizing a single conveyor, multiple conveyors, or other suitable devices.

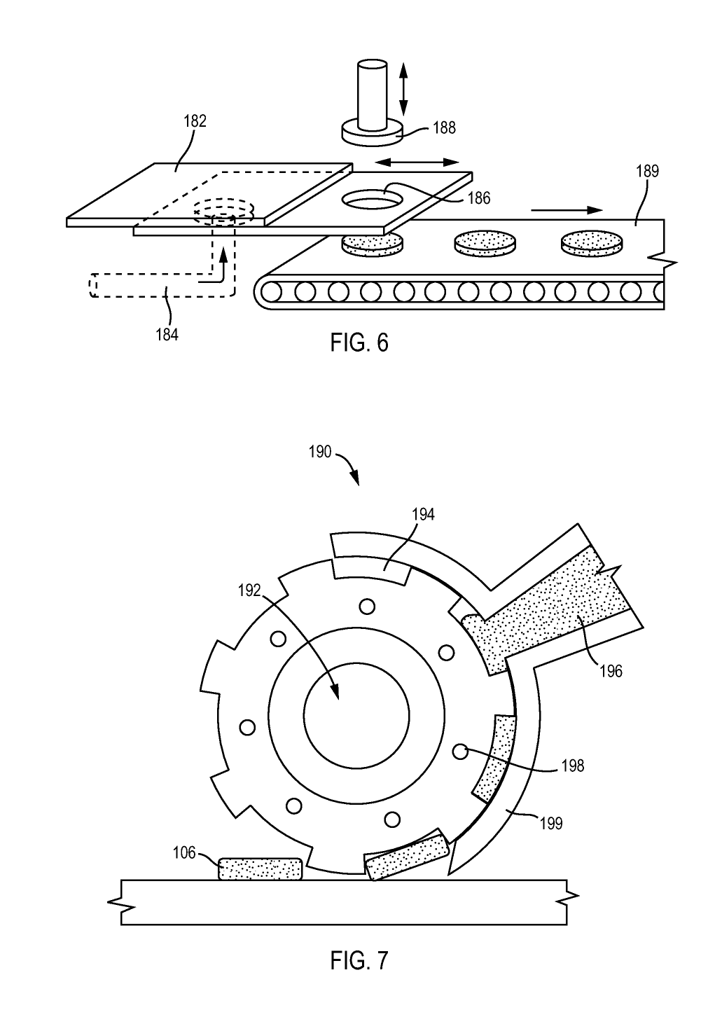

Referring to FIG. 6, a schematic illustration of a rotary former 190 is shown according to an exemplary embodiment. As shown in FIG. 6, rotary former 190 receives material 196 from a material supply device (not shown) such that the material (e.g., meat product, etc.) is received within one or recesses 194. Rotary former 190 includes an inner cylindrical portion 198 and an outer cylindrical portion 199 that define portions of the formed food component (shown as food component 106) A central portion 192 may include an air supply and/or vacuum that may be used to retain food components within and/or eject food components from recesses 194. Alternatively, food components may be retained and/or ejected from rotary former 190 using other methods such as a plunger, gravity, etc. Other forms of rotary formers or other devices may be used according to various other embodiments.

Referring to FIG. 7, a portion of a system for making a food component is shown according to an exemplary embodiment. As shown in FIG. 7, a supply device 184 (e.g., a pump, etc.) supplies meat and/or other material/ingredients to a cavity 186 on an oscillating plate 182. Plate 182 oscillates between a first position, where cavity 186 receives material from device 184, and a second position, where an ejector 188 pushes a formed food component out of cavity 186 and onto, for example, a conveyor 189. Cavity 186 may be of any of a variety of shapes and sizes, and may be used to form one or both of the top and bottom food products.

According to various alternative embodiments, in addition to the various formers, molds, and other devices shown herein that may be usable to form various food components, other devices and/or methods may be used. For example, food components may be sliced off using a slicing machine / slice-off wire (e.g., in the case of food component material being fed using a pump or other supply device). According to other embodiments, food components may be formed by a depositor, manual slicing / placement, or using a variety of other suitable methods or combinations thereof. All such embodiments are understood to be within the scope of the present disclosure.

While various references are made to “whole muscle” and “meat” portions, it should be understood that according to various alternative embodiments, the components described herein may be made of a wide variety of non-whole muscle and/or non-meat components, including ground meats or other ground food components, etc. Further, whole (e.g., unitary) pieces of meat may be used in some embodiments. All such variations in the make-up of the food components and filling are to be understood to be within the scope of the present disclosure.

Referring now to FIG. 8, a food product assembly system 210 is shown according to an exemplary embodiment and is configured to assemble multiple food components into food product 100 (see FIG. 2). According to an exemplary embodiment, the system is configured for automating the use of fully cooked whole muscles that are cut into predetermined shapes (e.g., pork chop shape, chicken breast shape, filet mignon shape, etc.). According to an exemplary embodiment, the system produces a stuffed protein (e.g., meat, soy, or other protein) food product. System 210 includes a central or main conveyor 212 for assembling the stuffed protein food product that is fed by separate individual supply or component conveyors 216, 218, 220 that supply each of the components to (main) conveyor 212. Main conveyor 212 provides a series of receptacles 214 that receive the food components in a predetermined order. Receptacles 214 may be provided in the conveyor itself, on trays, on packaging, or the like. Such packaging may be a sheet of plastic with a plurality of pockets formed therein. According to an exemplary embodiment, system 210 includes a supply or component conveyor 216 for bottom portion 106, a component conveyor 218 for filling 104, and a conveyor 220 for top portion 102. According to other embodiments, additional component conveyors may be provided for additional components or ingredients.

Each of the component conveyors for top portion 102 and bottom portion 106 includes a hopper 222, a meat stuffing apparatus 224, a conveyor, and a transfer apparatus that deposits (e.g., drops, places, etc.) the food component at a predetermined location on (main) conveyor 212.

According to an exemplary embodiment, whole muscle meat is loaded into the hopper. The hopper receives meat in random, scattered, or non-uniform orientations. A conveying device (e.g., helix, screw, etc.) conveys the whole muscle to the meat stuffer apparatus where the meat is injected or otherwise forced into a cavity (e.g., a mold). From the meat stuffer area, the formed component is conveyed to the transfer apparatus, which deposits (e.g., drops, places, etc.) the food component at a predetermined location on the (main) conveyor 12. This apparatus may be a retracting belt, flex loader, pick-and-place loader, or the like. In some embodiments, the bottom components are dropped by the transfer apparatus into the pockets in the receptacles or pockets on the main conveyor. Alternatively, whole muscle portions may be split or cut in half to form the top portion and the bottom portion.

Stuffing or filling components are prepared in-line (i.e., at a station on the component conveyor) or delivered to the hopper ready for dispensing. Filling 104 is extruded and cut into predetermined portions and conveyed to the transfer apparatus. The transfer apparatus deposits filling 104 onto bottom component 106 in packaging pockets 214. According to various alternative embodiments, filling 104 may be preformed and manually delivered or placed onto a conveyor, packaging, another food component, or the like.

In preparing top component 102, similar to the preparation of bottom component 106, meat is metered from a hopper to the meat stuffing apparatus. The meat stuffing apparatus forms top component 102 (e.g., meat or protein, etc.), which is formed into a desired shape for top food component 102 to mate with bottom component 106 and enclose filling 104. Top component 102 is conveyed to another transfer apparatus and deposited (e.g., dropped or placed) onto filling 104 and bottom component 106 in packaging pockets 214. The package may then be sealed, vacuum-packaged, and cooked to bind the top and bottom components together around the filling.

Referring also to FIG. 9, steps in the assembly of a stuffed food product assembled using the system of FIG. 8 are shown according to an exemplary embodiment. The base or bottom component 106 of meat is formed to a desired shape and size and includes a depression or recess 108 for receiving the stuffing or filling 104. Filling 104 is deposited on top of a bottom component 106. Recess 108 is intended to center filling 104 on bottom component 106 and inhibit filling 104 from moving relative to bottom component 106. Top component 102 of meat is formed to the mirror image of bottom component 106 and placed on top of bottom component 106 to enclose filling 104.

After assembly in the packaging recesses, a cover sheet is coupled to the base packaging to cover the pockets. A vacuum may then be applied to the packaging Food product 100 may then be cooked/heated to shrink or compress the assembled food product and assist the binding of the upper and lower protein portions. Food product 100 may be cooked (e.g., in an oven) immersed in hot water (e.g., about 190 degrees Fahrenheit, etc.) to fully cook the meat and further bind or bond the upper and lower portions. The meat generally includes binding protein so that bottom portion 106 bonds with the top portion 104 to “seal in” the filling.

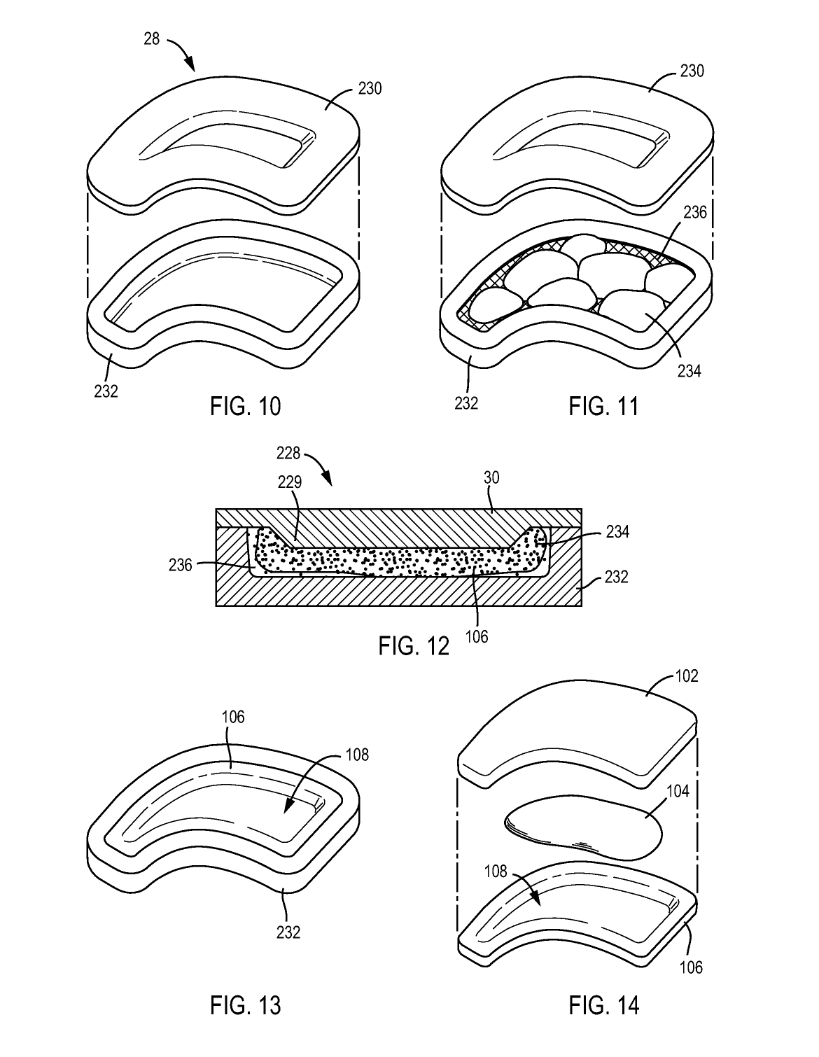

Referring to FIGS. 10-14, further detail of the formation of food product 100 is illustrated according to an exemplary embodiment. Cut whole muscles and binder protein or binder meat (e.g., wing meat, thigh meat, emulsified meat, etc.) are placed in a hopper and injected into a mold 228 to form the top or bottom food component 102, 106.

Referring specifically to FIG. 10, a mold 228 in the general shape of a pork chop is shown according to an exemplary embodiment. Mold 228 includes a bottom portion 232 and a top portion 230. Bottom portion 232 is configured to receive the whole muscles and binder meat. Top portion 230 is configured to compress the whole muscles and meat and to form a depression or recess 108. While mold 228 is illustrated in a pork chop shape, according to other exemplary embodiments, mold 228 may be in the shape of a chicken breast, steak, or other meat shape. According to various exemplary embodiments, mold 228 may be metal, plastic, or a variety of materials suitable for use with food products and of sufficient strength to hold its shape when compressed.

Referring to FIG. 11, mold 228 is filled with cut portions of whole muscle 234 and with binder meat 236 from the hopper. While specific amounts, sizes, and configurations of whole muscle and binder meat are illustrated, according to other exemplary embodiments, the whole muscle size may be larger or smaller, the amount of binder meat may be greater or smaller, and whole muscle 234 and binder meat 236 may be deposited in different or random configurations within the mold.

Referring to FIG. 12, a cross-section illustrates top portion 230 of mold 228 compressing whole muscles 234 and binder meat 236 in bottom portion 232 of mold 228. The edges of top portion 230 of mold 228 generally mate with the edges of bottom portion 232 of mold 228. The shape of top portion 230 includes a protruding area 229 configured to compress whole muscles 234 and binder meat 236 as well as form depression or recess 108 in the compressed meat product. According to various exemplary embodiments, top mold portion 230 may be pressed onto bottom mold portion 232 using any automated or manual process.

Referring to FIG. 13, the compressed meat product in bottom portion 232 of mold 228 with top portion 230 of mold 228 removed is illustrated according to an exemplary embodiment. Whole muscle 234 and binder meat 236 may generally be compressed into a single shape. When whole muscles 234 and binder meat 236 are compressed, binder meat 236 joins the various whole muscles together into a single compressed meat component. It is noted that according to other exemplary embodiments, depression 108 may be of another shape based on the shape of protrusion 229 of top portion 230 of the mold 228.

Referring to FIG. 14, the compressed meat product forms a bottom (or top) component of the stuffed food product, which is deposited into a pocket on packaging on a conveyor as shown in FIG. 8. Depression or recess 108 of bottom component 106 then receives filling 104. Top component 102, which may have a shape that is a mirror image of bottom component 106, is also formed similar to the process of FIGS. 10-13. The edges of top component 102 mate with the edges of bottom component 106. Top component 102 may include a depression or recess that is configured to fit over and enclose filling 104. Binder meat 236 or binder protein of each of top and bottom portions 102, 106 are configured to seal the top and bottom components 102, 106 together under a vacuum to seal filling 104 within the top and bottom components.

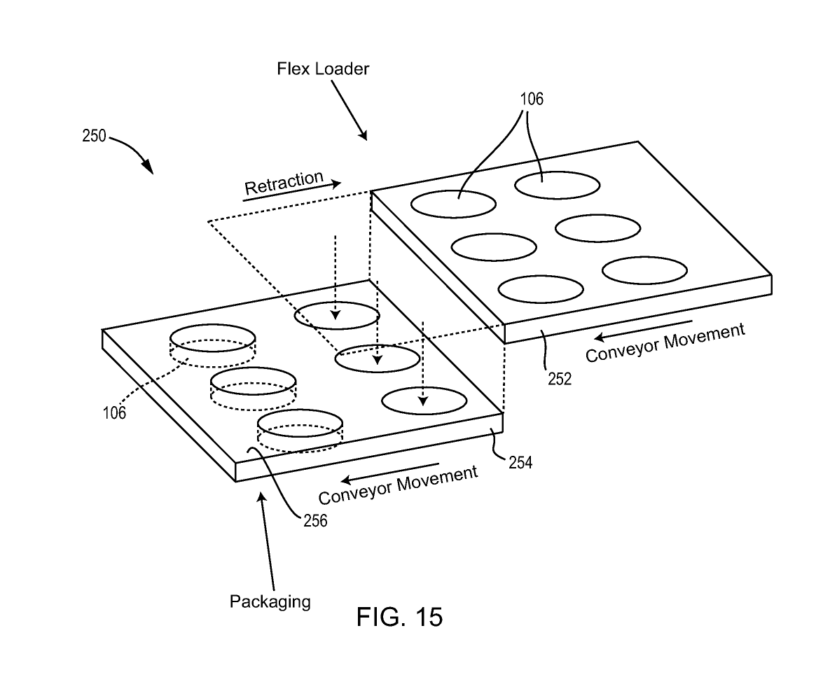

Referring to FIG. 15, the operation of a transfer apparatus, shown as a retracting belt system 250, that may be used in the system of FIG. 8 is illustrated according to an exemplary embodiment. A food component (e.g. food component 106) travels along a conveyor 252 to a retracting belt. The retracting belt positions one or more rows of the food component over packaging 256 located on another conveyor 254. Packaging 256 may comprise a polymer sheet with the depressions or recesses formed therein (e.g., as pockets or receptacles). The retracting belt retracts at a speed that is sufficient for the food product to not travel with the retracting belt and the food components fall or drop into individual pockets of packaging 254. Packaging 254 also moves on conveyor 254 so that appropriate food components can drop into the appropriate pocket at subsequent stations.

The retracting belt system is generally configured to position a number of bottom components 106 over the top of the packaging pockets and rapidly withdraw (retract), causing bottom components 106 to drop in packaging 256. The retracting belt preferably comprises a conveyor belt and a retract mechanism. The belt moves to convey the components to a predetermined position relative to its end. The retract mechanism induces a rapid linear movement (e.g., in an opposite direction as the movement of the component when on the conveyor belt). According to some exemplary embodiments, the retracting belt may be configured to hold any number of rows and/or columns of a food component and may include a belt material that is generally sanitary and that has a coefficient of friction low enough to preserve the matrix configuration when the retracting belt is retracted.

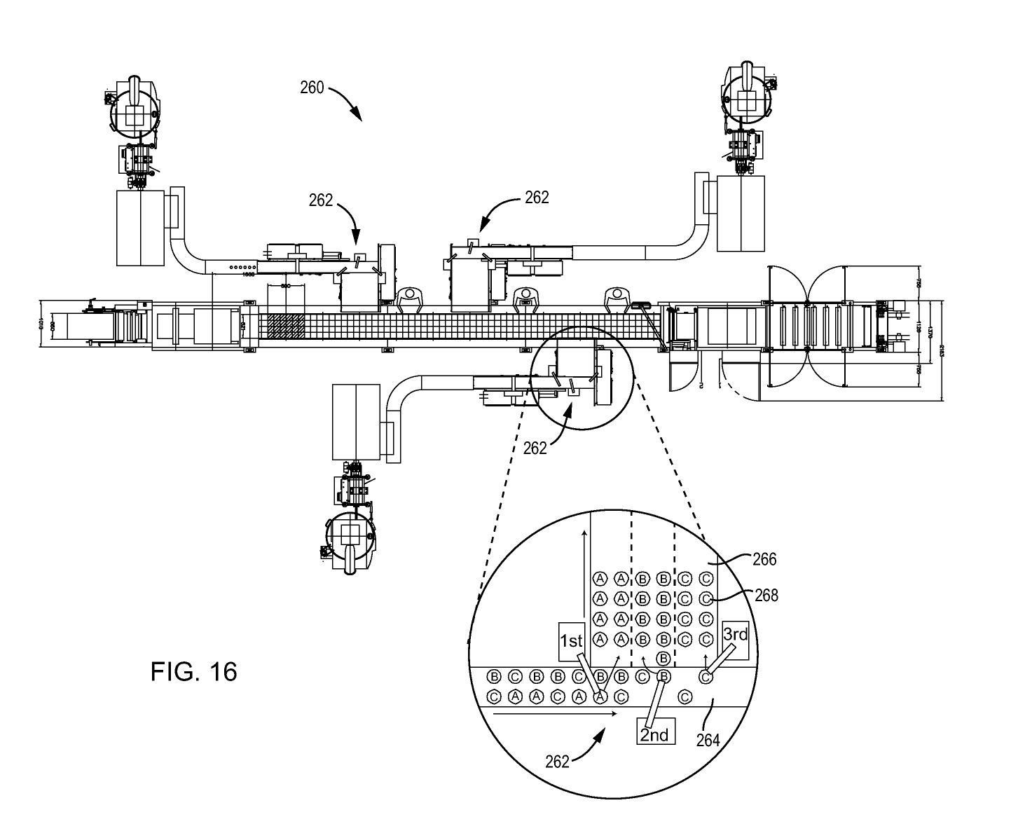

Referring to FIG. 16, a food product assembly system 260 similar to system 210 of FIG. 8 is illustrated, according to another exemplary embodiment. The retracting belts are replaced with pick-and-place apparatus (flex pickers) 262, which are intended to provide faster loading. Each flex picker may be configured to move components 268 (e.g., meat components, filling components) from a first conveyor 264 to a second conveyor 266 moving in a different direction (e.g., a transverse direction). Each flex picker may be preprogrammed (e.g., via hardwiring, programmable hardware, or a software routine) to pick up specific components 268 from the first conveyor 264 and place them in specific columns of the second conveyor 266. According to various other embodiments, other methods of conveying food components may be utilized.

While a specific method for moving components to the second conveyor using three flex pickers has been illustrated, according to other exemplary embodiments, any suitable method or number of flex pickers may be used that is timed with the first conveyor speed in order to move all of the components. While a specific number of columns, rows, and food components are illustrated in the figures, any number of supply conveyors, or rows, columns, or food components on the conveyors may be used with an appropriately sized conveyors, retracting belt, flex pickers, and packaging.

In some embodiments, additional mechanical processing (e.g., crimping) may be conducted at various stages in the preparation of the food products disclosed herein. For example, in some embodiments, the top and/or bottom food products may be dough or bread-based food products such that the periphery of the uncooked components may be “crimped” together (e.g., in a corrugated, wavy, or other configuration). In some embodiments, the top/bottom components may be pie type dough, biscuit dough, yeast-raised products, etc., and the filling may be one or more of a sausage product, cheese product, other meat (e.g., ham bacon, etc.). Further, the packing may be a flow wrap packaging, a formed film packaging, or other suitable packaging.

It is noted that according to various exemplary embodiments, the meat or whole muscle of the stuffed food product can be beef, pork, chicken, turkey, fish, or any other meat product or meat substitute. Further, the filling can be any filling including meat, grain, vegetables, fruit, sauce, dairy, cheese, additives, or any combination thereof.

It is important to note that the terms “food product,” “food component,” and “stuffed food product,” are intended to be broad terms and not terms of limitation. These components may be used with any of a variety of food products or arrangements and are not intended to be limited to filling and meat stuffed food product. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to mechanical, fluid, or electrical relationship between the two components.

It is also important to note that the construction and arrangement of the elements of the food assembly system as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, while the components of some disclosed embodiments are illustrated as a system and process designed for stuffed meat product, the features of the disclosed embodiments have a much wider applicability—the food assembly system design is adaptable for other stuffed food products that include multiple components. Further, the size of the various components and the size of the containers can be widely varied. Accordingly, all such modifications are intended to be included within the scope of the present invention. The order or sequence of any process or method steps may be varied or re-sequenced according to alternative embodiments. Other substitutions, modifications, changes and/or omissions may be made in the design, operating conditions and arrangement of the preferred and other exemplary embodiments without departing from the spirit of the present invention.

What is claimed is:

1. A method of making a food product, the method comprising:
forming a first food component;
providing a filling to the first food component;
forming a second food component and providing the second food component on the first food component and the filling wherein the first food component is in contact with the second food component at least about their respective peripheries;
sealing the first and second food components and the filling within packaging and applying a vacuum to the packaging;
cooking the first and second food components and the filling within the packaging to bond the first and second food components together.

2. The method of claim 1, wherein the first and second food components are meat-based food components.

3. The method of claim 2, further comprising extracting meat protein from meat prior to sealing the first and second food components and the filling with the packaging.

4. The method of claim 2, wherein the step of cooking the first and second food component comprises denaturation of the extracted meat protein from the first and second food components.

5. The method of claim 1, wherein the packaging is a shrinkable packaging configured to compress the first food component toward the second food component.

6. The method of claim 1, wherein at least one of the first and second food components comprises a recess to receive the filling component.

7. The method of claim 1, wherein the first and second food components are different sizes.

8. The method of claim 7, wherein the first food component is larger than the second food component and configured to drape over the filling component and the second component.

9. The method of claim 1, wherein forming the first and second food products comprises rotary forming at least one of the first and second food products.

10. The method of claim 1, further comprising processing at least one of the first and second food components prior to packaging to provide at least one of a surface texture and a seasoning to the at least one of the first and second food components.

11. The method of claim 1, wherein the filling comprises at least one of a cheese product, a dough product, a meat-based product, a vegetable product, a sauce, seasoning, or combinations thereof.

12. A method of making a food product, the method comprising:
forming a first food component;
positioning a filling on top of the first food component;
forming a second food component;
positioning the second food component on the first food component and the filling to enclose the filling between the first and second food components;
sealing the first and second food components and the filling within packaging and applying a vacuum to the packaging;
at least partially cooking at least one of the first and second food components.

13. The method of claim 12, wherein at least partially cooking at least one of the first and second food components comprises cooking the first and second food components to a fully-cooked state within the packaging.

14. The method of claim 12, wherein cooking the first and second food components to a fully-cooked state creates a bond between the first and second food components around the filling.

15. The method of claim 12, wherein the packaging is a shrinkable packaging configured to be shrunk around the first and second food components and the filling.

16. The method of claim 12, wherein at least one of the first and second food components is a protein-based food component.

17. The method of claim 12, wherein the filling comprises at least one of a grain-based product, a cheese product, and/or a sauce.

18. The method of claim 12, further comprising:
providing a main conveyor configured to convey the packaging having a plurality of receptacles;
providing a first supply conveyor system configured to form the first food component with a recess and to deliver the first food component to receptacles in the packaging;
providing a second supply conveyor system configured to deliver the filling into the recess on the first food component;
providing a third supply conveyor system configured to form the third food component with a recess and to deliver the third food component onto the second food component.

19. A method of making a food product, the method comprising:
extracting meat proteins from meat;
forming a first meat-based food component from the meat;
positioning a filling on the first meat-based food component;
forming a second meat-based food component;
positioning the second meat-based food component on the first meat-based food component;
sealing the first and second meat-based food components and the filling within packaging and applying a vacuum to the packaging;
wherein the extracted meat proteins in the first and second meat-based food components provides a sealable area between the first and second meat-based food components, the sealable area configured to provide a bond between the first and second meat-based food components when the first and second meat-based food components are cooked.

20. The method of claim 19, further comprising cooking the first and second meat-based food components and the filling within the packaging.

21. The method of claim 19, further comprising forming at least one of the first meat based food component and the second meat-based food component using a rotary former.

22. The method of claim 19, further comprising providing a surface treatment to at least one of the first meat-based food component and the second meat-based food component, the surface treatment comprising at least one of par-cooking, char-marking, flame-grilling, and seasoning.

23. A packaged food product comprising:
a first meat-based food component;
a second meat-based food component;
a first filling located between the first meat-based food component and the second food meat-based component;
sealed vacuum packaging containing the first meat-based food component, the filling, and the second meat-based food component;
wherein at least an outer periphery of the first meat-based food component is bonded to an outer periphery of the second meat-based food component by heat applied to the sealed vacuum packaging.

24. The packaged food product of claim 23, wherein the heat is provided by steam, heated water, heated air, or combinations thereof.

25. The packaged food product of claim 23, further comprising a second filling located between the first meat-based food component and the second food meat-based component.

26. The packaged food product of claim 23, wherein the first meat-based food component and/the second food meat-based component comprise whole meat muscle, pieces of whole meat muscle compressed together, ground meat, emulsified meat, or combinations thereof.
